(19) United States
(12) Patent Application Publication
(10) Pub. No.: US 2025/0379791 A1
(43) Pub. Date: Dec. 11, 2025

(54) AUTOMATED DELIVERY OF FIBER BROADBAND SERVICE

(71) Applicant: AT&T Intellectual Property I, L.P., Atlanta, GA (US)

(72) Inventor: Jayant Ragde, Duluth, GA (US)

(21) Appl. No.: 18/737,041

(22) Filed: Jun. 7, 2024

(51) Int. Cl. H04L 41/0894; H04B 10/27; H04L 41/5006; H04L 43/0811

(52) U.S. Cl. CPC H04L 41/0894; H04B 10/27; H04L 41/5006; H04L 43/0811

(57) ABSTRACT

One example of a method for providing automated delivery of fiber broadband service includes detecting network traffic from an endpoint device connected to an optical network terminal for which a fiber broadband service has been discontinued, wherein the network traffic has been rerouted by a broadband network gateway, delivering, to the endpoint device, information associated with at least one communication service plan that is available to a customer site associated with the optical network terminal, receiving a selection of the at least one communication service plan from the endpoint device, configuring a customer policy for the customer site in accordance with the selection, and delivering the customer policy to the broadband network gateway with an instruction to replace a default policy associated with the customer site with the customer policy.

The present disclosure relates generally to fiber broadband services, and relates more particularly to devices, non-transitory computer-readable media, and methods for providing automated delivery of fiber broadband service.

### BACKGROUND

Fiber broadband is a type of high-speed Internet service that utilizes fiber optic cables (as opposed to, for example, copper phone lines or coaxial cable) to transmit data. In fiber-to-the-premises (FTTP) connections, the fiber optic cable runs all the way into the customer premises and is connected directly to an optical network terminal (ONT) which converts fiber signals (i.e., pulses of light) into data that can be rendered by user endpoint devices at the customer premises, such as personal computers, set top boxes, smart televisions, and the like. The ONT is typically configured by the fiber broadband service provider with a policy that specifies how traffic from the ONT is to be processed. For instance, the policy may determine as to where the traffic from the ONT is to be routed and how much bandwidth is to be allocated to the customer to whom the ONT belongs.

### SUMMARY

The present disclosure broadly discloses methods, computer-readable media, and systems providing automated delivery of fiber broadband service. In one example, a method performed by a processing system in a communications service provider access network includes detecting network traffic from an endpoint device connected to an optical network terminal for which a fiber broadband service has been discontinued, wherein the network traffic has been rerouted by a broadband network gateway, delivering, to the endpoint device, information associated with at least one communication service plan that is available to a customer site associated with the optical network terminal, receiving a selection of the at least one communication service plan from the endpoint device, configuring a customer policy for the customer site in accordance with the selection, and delivering the customer policy to the broadband network gateway with an instruction to replace a default policy associated with the customer site with the customer policy.

In another example, a non-transitory computer-readable medium may store instructions which, when executed by a processing system in a communications service provider access network, cause the processing system to perform operations. The operations may include detecting network traffic from an endpoint device connected to an optical network terminal for which a fiber broadband service has been discontinued, wherein the network traffic has been rerouted by a broadband network gateway, delivering, to the endpoint device, information associated with at least one communication service plan that is available to a customer site associated with the optical network terminal, receiving a selection of the at least one communication service plan from the endpoint device, configuring a customer policy for the customer site in accordance with the selection, and delivering the customer policy to the broadband network gateway with an instruction to replace a default policy associated with the customer site with the customer policy.

In another example, a device in a communications service provider access network may include a processing system including at least one processor and a non-transitory computer-readable medium storing instructions which, when executed by the processing system, cause the processing system to perform operations. The operations may include detecting network traffic from an endpoint device connected to an optical network terminal for which a fiber broadband service has been discontinued, wherein the network traffic has been rerouted by a broadband network gateway, delivering, to the endpoint device, information associated with at least one communication service plan that is available to a customer site associated with the optical network terminal, receiving a selection of the at least one communication service plan from the endpoint device, configuring a customer policy for the customer site in accordance with the selection, and delivering the customer policy to the broadband network gateway with an instruction to replace a default policy associated with the customer site with the customer policy.

In some examples, the at least one communication service plan may comprise a broadband service plan having one or more selectable parameters. Thus, information about the broadband service plan may be delivered to the endpoint device. Upon receiving a selection of a broadband service plan with the one or more selectable parameters having been selected from a user of the endpoint device, a customer policy for the customer site may be applied to the broadband network gateway in accordance with the selection.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for providing automated delivery of fiber broadband service may operate;

FIG. 2 illustrates a flowchart of an example method for providing automated delivery of fiber broadband service, in accordance with the present disclosure;

FIG. 3 illustrates a flowchart of an example method for providing automated delivery of fiber broadband service, in accordance with the present disclosure; and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for providing automated delivery of fiber broadband service. As discussed above, fiber broadband is a type of high-speed Internet service that utilizes fiber optic cables (as opposed to, for example, copper phone lines or coaxial cable) to transmit data. In fiber-to-the-premises (FTTP) connections, the fiber optic cable runs all the way into the customer premises and is connected directly to an optical network terminal (ONT) which converts fiber signals (i.e., pulses of light) into data that can be rendered by user endpoint devices at the customer premises, such as personal computers, set top boxes, smart televisions, and the like. The ONT is typically configured by the fiber broadband service provider with a policy that specifies how traffic from the ONT is to be processed. For instance, the policy may determine as to where the traffic from the ONT is to be routed and how much bandwidth is to be allocated to the customer to whom the ONT belongs.

When a new customer wants to subscribe to fiber broadband service, the new customer typically may contact the service provider by phone (e.g., cellular or landline) or online (e.g., using an existing, non-fiber broadband Internet service) to request service. In some cases, an ONT may already be present at the customer premises (e.g., due to a prior occupant of the customer premises having been a fiber broadband service subscriber or due to the new customer having previously subscribed to fiber broadband service). However, if the fiber broadband service to the ONT was discontinued at some point, then all policies relating to the routing of traffic from the ONT would have been removed. As a result, traffic cannot flow to or from the ONT. In order to restore the fiber broadband service, the fiber broadband service provider may dispatch a human technician to the customer premises to configure the ONT for service. Dispatching the human technician may be costly to the service provider, as well as delay the provision of the fiber broadband service to the new customer.

Examples of the present disclosure apply a default policy to a fiber broadband ONT when fiber broadband service to the ONT is discontinued, where the default policy allows outbound traffic to continue flowing from the ONT (i.e., toward the fiber broadband network) despite the discontinued service. When a user endpoint device is connected to the ONT (e.g., via Ethernet cable), any traffic to and from the ONT will be routed to a dedicated internal web server. The dedicated internal web server may function as a self-service portal that provides information on fiber broadband (and potentially other) services that are available to the customer premises as well as a mechanism via which a new customer may subscribe to any of the services.

When a new customer attempts to subscribe to a service via the self-service portal, any conventional backend processes such as credit checks and address verification may be performed. Once the backend processes are completed and the new customer is approved for the service, the ONT may be automatically configured to activate the service via a remotely executed configuration process. In this way, fiber broadband service can be fully restored to an existing ONT in a matter of minutes, as opposed to the potential days that it may take to dispatch a human technician.

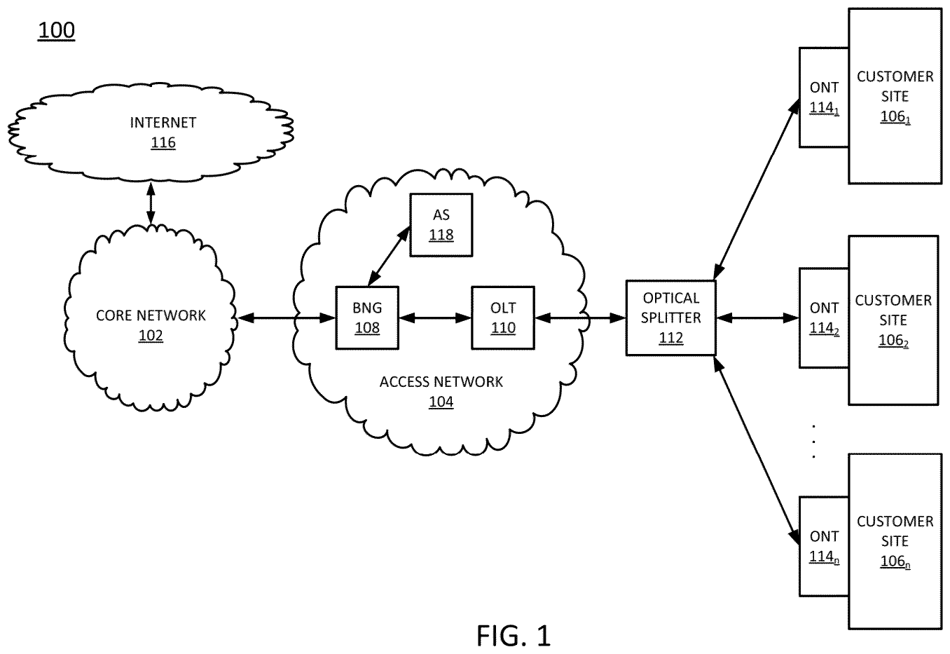

Within the context of the present disclosure, a “policy” is understood to refer to a set of rules that specifies how traffic from a fiber broadband customer site is to be processed (e.g., how traffic is directed from the customer site to a service provider core network/the Internet and vice versa). A “customer policy” is understood to refer to a policy that is associated with a customer site that is associated with an active fiber broadband service subscription. A customer policy allows a two-way flow of traffic between the customer site and a service provider core network/the Internet. A “default policy” is understood to refer to a policy that is associated with a customer site at which a prior fiber broadband service subscription has been discontinued. A default policy allows a two-way flow of traffic between the customer site and a dedicated application server that functions as a fiber broadband service portal. In one example, a default policy does not allow the customer site to send traffic to or receive traffic from any endpoint other than this dedicated application server. These and other aspects of the present disclosure are discussed in greater detail below in connection with the examples of FIGS. 1-4.

To further aid in understanding the present disclosure, FIG. 1 illustrates an example system 100 in which examples of the present disclosure for providing automated delivery of fiber broadband service may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, 6G or any other future generations of network technology, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks, such as access network 104, and with the Internet 116. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. For ease of illustration, various elements of the core network 102 (such as application servers, databases, edge servers, routers, and the like) are omitted from FIG. 1.

In one example, the access network 104 may comprise an optical access network (OAN), i.e., a network that utilizes optical fiber as the primary transmission medium for data. To this end, the access network 104 may include at least a broadband network gateway (BNG) 108, an optical line terminal (OLT) 110, and an application server (AS) 118. Operations of the BNG 108, OLT 110, and AS 118 are described in greater detail below.

In one example, the operator of the core network 102 may provide a cable television service, an IPTV service, a media streaming service, or any other types of communication services to subscribers via access network 104. In one example, the core network 102 may be operated by a communication network service provider (e.g., an Internet service provider, or a service provider who provides Internet services in addition to other communication services). The core network 102 and the access network 104 may be operated by different service providers, the same service provider or a combination thereof, or the access network 104 may be operated by an entity having core businesses that are not related to communications services, e.g., corporate, governmental, or educational institution LANs, and the like.

In one example, the access network 104 may be in communication with one or more customer sites 106₁-106ₙ (hereinafter individually referred to as a “customer site 106” or collectively referred to as “customer sites 106”). The access network 104 may transmit and receive communications between the customer sites 106, between the customer sites 106 and the Internet 116, between the customer sites 106 and the core network 102, and so forth. In one example, each of the customer sites 106 may include one or more user endpoint devices such as personal computers, set top boxes, smart televisions, smart phones, Internet of Things (IoT) devices, a pair of smart eye glasses or goggles, or the like. Each customer site 106 may further include a respective optical network terminal (ONT) 114₁-114ₙ (hereinafter individually referred to as an “ONT 114” or collectively referred to as “ONTs 114”) to convert fiber signals (i.e., pulses of light) received from the access network 104 into data that can be rendered by the user endpoint devices at the customer site 106.

Typically, when fiber broadband service is provisioned for a customer, a customer policy is configured for the customer at the BNG 108. The BNG 108 is the access point through which fiber broadband subscribers connect to the core network 102 and Internet 116. To this end, the BNG 108 may store a respective policy for each customer for whom fiber broadband service has been provisioned. The customer policy may specify how traffic from the customer site 106 associated with the customer is processed (e.g., how traffic is directed from the customer site 106 to the core network 102 and vice versa). For instance, the customer policy may specify the bandwidth allocated to the customer, routing information associated with the customer, or the like.

In operation, the BNG 108 may establish and manage subscriber sessions for the customer sites 106. When a session is active, the BNG 108 may aggregate traffic from various subscriber sessions from the access network 104 and route the aggregated traffic to the core network 102. In one example, the BNG 108 may be deployed at the edge of the access network 104, such as in an edge router.

Electrical signals (e.g., network traffic) flowing from the core network 102 (or from the Internet 116 through the core network 102) toward the customer sites 106 may be routed by the BNG 108 to the OLT 110. The OLT 110 functions as the service provider-side endpoint of the OAN and may perform conversions between the electrical signals used by the core network 102 and the optical signals (i.e., pulses of light) used by the access network 104. Electrical signals which have been converted by the OLT 110 into optical signals may be copied by an optical splitter 112, which delivers one copy of the optical signal(s) to each ONT 114. Each ONT 114 then converts the received optical signals back into electrical signals which may be utilized by the user endpoint devices at the customer site 106.

When a customer terminates their fiber broadband service, the customer policy that was created for the customer during service provisioning is typically deleted from the BNG 108. No network traffic may flow from a customer site to the core network 102 (or vice versa) unless the BNG 108 has a customer policy for the customer site. Thus, once a customer policy is deleted from the BNG 108, the customer site associated with the deleted customer policy typically has no way to access the core network 102 and/or Internet 116.

According to examples of the present disclosure, however, rather than delete the customer policy when fiber broadband service is terminated, the customer policy is replaced at the BNG 108 with a default policy that allows traffic to continue to flow from the customer site 106 toward the core network 102, but directs this outbound network traffic from the customer site 106 to the AS 118. In this case, the AS 118 may function as a Web portal for allowing customers to subscribe to fiber broadband and other services. For instance, the AS 118 may deliver information to the customer site 106 (e.g., to a user endpoint device at the customer site 106 that is connected to the ONT 114) that provides information (e.g., data rate, pricing, service provider, etc.) about one or more fiber broadband subscription plans that are available to the customer site 106. The information may further include a mechanism by which a user at the customer site 106 may select and subscribe to one of the fiber broadband subscription plans.

In one example, in response to a selection of a fiber broadband subscription plan by the user, the AS 118 may initiate provisioning of the selected fiber broadband subscription plan. In one example, since the ONT 114 already exists at the customer site 106 and is already configured for fiber broadband service, initiating the provisioning may include creating a new customer profile for the customer site 106 on the BNG 108. The new customer profile may allow traffic to flow from the customer site 106 to the core network 102 (and vice versa). The new customer profile may be configured to support the level of fiber broadband service (e.g., data rate) associated with the selected fiber broadband subscription plan. In further examples, the AS 118 may also engage any backend systems that may be necessary to perform additional processes needed to establish service, such as credit checks, address confirmation, and the like. Thus, as long as a preexisting ONT 114 is present at a customer site 106, fiber broadband service may be restored to the customer site 106 in a matter of minutes, without requiring a human technician to be dispatched to the customer site 106.

In further examples, the Web portal provided by the AS 118 may be configured to provide information about services in addition to fiber broadband service which may be available to the customer site 106. For instance, services such as television services, streaming media (e.g., video, audio, or other) services, telephone services, and other services may be available to the customer site 106. At least some of these other services may be offered by service providers other than the fiber broadband service provider, and the fiber broadband service provider may have an agreement with the other service providers to provide information about these other services to prospective subscribers. As with the fiber broadband services, the Web portal may provide a mechanism by which a user at the customer site 106 may select and subscribe to a subscription plan for one or more of these other services. The customer policy that is created by the AS 118 on the BNG 108 may allow traffic to flow from the customer site 106 to core networks associated with the providers of any other selected services (and vice versa).

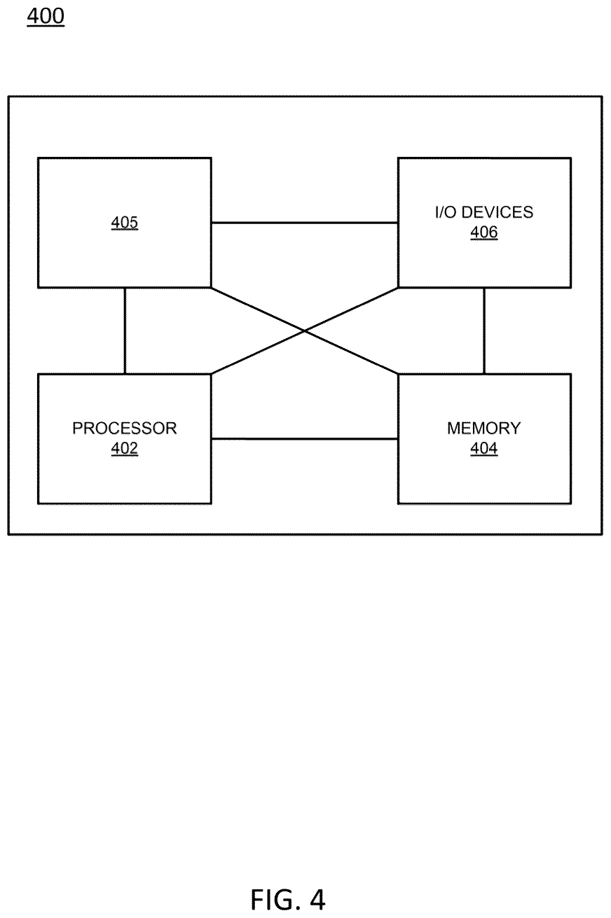

The AS 118 may comprise one or more physical devices, e.g., one or more computing systems or servers, such as computing system 400 depicted in FIG. 4, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access network 104, and/or Internet 116 may comprise a content distribution network (CDN) having ingest servers, edge servers, and the like. Similarly, although only one access network 104 is shown, in other examples, the access network 104 may comprise a plurality of different access networks that may interface with the core network 102 independently or in a chained manner. For example, UE customer sites 106 may communicate with the core network 102 via different access networks. Thus, these and other modifications are all contemplated within the scope of the present disclosure.

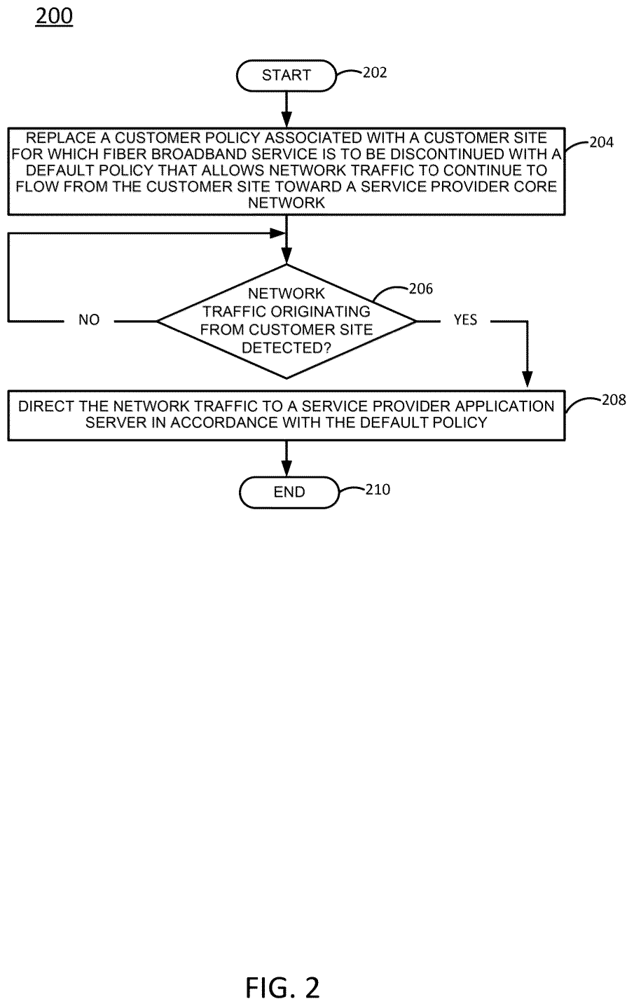

FIG. 2 illustrates a flowchart of an example method 200 for providing automated delivery of fiber broadband service, in accordance with the present disclosure. In one example, steps, functions and/or operations of the method 200 may be performed by a device as illustrated in FIG. 1, e.g., a broadband network gateway (BNG) 108 in a service provider access network 104 (or any one or more components thereof). In another example, the steps, functions, or operations of method 200 may be performed by a computing device or system 400, and/or a processing system 402 as described in connection with FIG. 4 below. For instance, the computing device 400 may represent a broadband network gateway in accordance with the present disclosure. For illustrative purposes, the method 200 is described in greater detail below in connection with an example performed by a processing system, such as processing system 402.

The method 200 begins in step 202. In step 204, the processing system may replace a customer policy associated with a customer site for which fiber broadband service is being discontinued with a default policy that allows network traffic to continue to flow from the customer site toward a service provider core network.

As discussed above, a customer site that subscribes to fiber broadband service may be associated with a customer policy that is stored and enforced at a broadband network gateway in a fiber broadband service provider's access network. The customer policy may specify how traffic from the customer site is processed (e.g., how traffic is directed from the customer site to a service provider core network/the Internet and vice versa).

A signal to replace the customer policy with the default policy may be received (e.g., from a human technician who is managing a subscriber account associated with the customer site, from an application server or Web portal via which a user at the customer site may cancel their fiber broadband service plan, from an order management system through which a user at the customer site may cancel their fiber broadband service plan, or the like) when a user at the customer site requests cancellation of existing fiber broadband service at the customer site. Although the customer policy may be replaced in the broadband network gateway with the default policy, an optical network terminal used to deliver the fiber broadband service may remain at the customer site.

As discussed above, the default policy may allow network traffic to flow from the customer site (via the existing broadband network gateway) toward the core network. That is, even though fiber broadband service for the customer site may be discontinued, if a new user (or even an existing user) connects a user endpoint device (e.g., a personal computer, a set top box, a smart television, an IoT device, or the like) to the existing broadband network gateway, the user endpoint device may be enabled to send network traffic toward the core network. However, the default policy may not allow network traffic to flow in the opposite direction (i.e., from a third party outside the core network to the customer site). Furthermore, the network traffic that is permitted to flow from the customer site toward the core network may be routed to a dedicated application server that functions as a self-service Web portal for establishing a fiber broadband service subscription.

In step 206, the processing system may determine whether network traffic originating from the customer site has been detected. As discussed above, an optical network terminal may remain in place at the customer site despite fiber broadband service to the customer site being discontinued. When a user connects a user endpoint device (e.g., a personal computer, a set top box, a smart television, an IoT device, or the like) to the optical network terminal, the default policy may enable the user endpoint device to send network traffic, via the optical network terminal, toward the service provider core network and/or the Internet. However, the network traffic may be intercepted by the processing system (e.g., by a broadband network gateway of which the processing system is a part), and the processing system may determine that, because the network traffic originated from the customer site, the default policy should be applied to the network traffic.

If the processing system determines in step 206 that the network traffic originating from the customer site has not been detected, then the method 200 may repeat step 206 until the processing system detects network traffic originating from the customer site. If, however, the processing system determines in step 206 that network traffic originating from the customer site has been detected, then the method 200 may proceed to step 208. In step 208, the processing system may direct the network traffic to a service provider application server in accordance with the default policy.

As discussed above, the processing system may determine that, because the network traffic originated from the customer site, the default policy should be applied to the network traffic. The default policy may specify that network traffic originating from the customer site should be routed to the service provider application server rather than to the service provider core network and/or the Internet.

In one example, the service provider application server may function as a Web portal that delivers, to the customer site (e.g., to a user endpoint device connected to the optical network terminal at the customer site), information about fiber broadband service subscription plans that are available to the customer site. For instance, the information may include data rates and pricing associated with a plurality of different fiber broadband subscription plans. In a further example, the application server may be further configured to receive a selection of a fiber broadband subscription plan from the customer site and to configure a new customer policy based on the selection. This new customer policy may be delivered to the processing system along with an instruction to replace the default policy with the new customer policy.

Once the processing system has directed the network traffic to the service provider application server in accordance with the default policy, the method 200 may end in step 210.

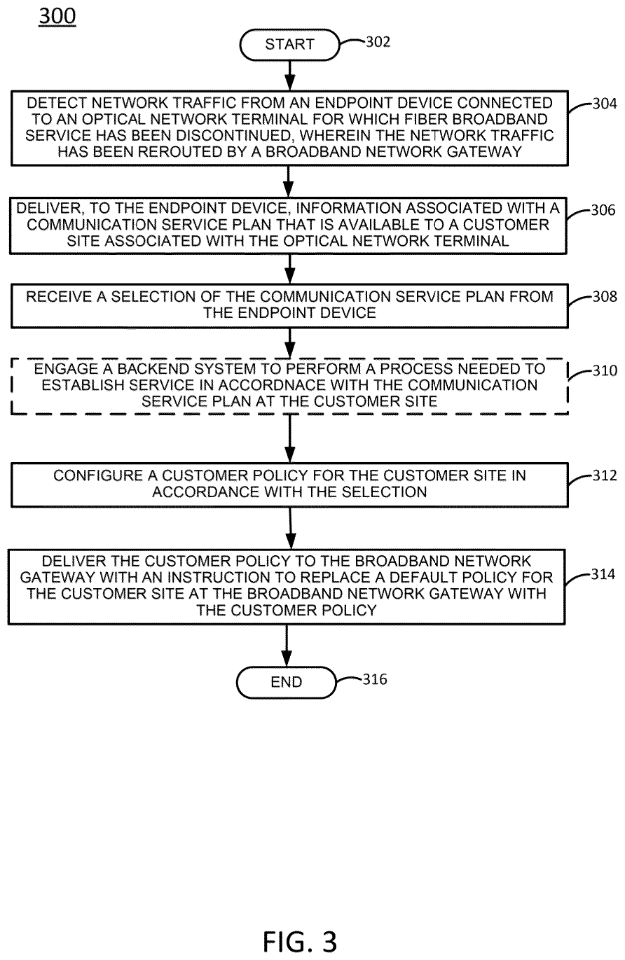

FIG. 3 illustrates a flowchart of an example method 300 for providing automated delivery of fiber broadband service, in accordance with the present disclosure. In one example, steps, functions and/or operations of the method 300 may be performed by a device as illustrated in FIG. 1, e.g., an AS 118 (or any one or more components thereof, such as an operating system). In another example, the steps, functions, or operations of method 300 may be performed by a computing device or system 400, and/or a processing system 402 as described in connection with FIG. 4 below. For instance, the computing device 400 may represent an application server in accordance with the present disclosure. For illustrative purposes, the method 300 is described in greater detail below in connection with an example performed by a processing system, such as processing system 402.

The method 300 begins in step 302. In step 304, the processing system may detect network traffic from an endpoint device connected to an optical network terminal for which fiber broadband service has been discontinued, wherein the network traffic has been rerouted by a broadband network gateway.

As discussed above, a customer site that subscribes to fiber broadband service may be associated with a customer policy that is stored and enforced at a broadband network gateway in a fiber broadband service provider's access network. The customer policy may specify how traffic from the customer site is processed (e.g., how traffic is directed from the customer site to a service provider core network/the Internet and vice versa). When the fiber broadband service is discontinued at the customer site, the customer policy may be replaced in the broadband network gateway with the default policy, but an optical network terminal used to deliver the fiber broadband service may still remain at the customer site.

As also discussed above, the default policy may allow network traffic to flow from the customer site (via the existing broadband network gateway) toward the core network. That is, even though fiber broadband service for the customer site may be discontinued, if a user connects a user endpoint device (e.g., a personal computer, a set top box, a smart television, an IoT device, or the like) to the existing broadband network gateway, the user endpoint device may be enabled to send network traffic toward the core network. However, the default policy may not allow network traffic to flow in the opposite direction (i.e., from outside the core network to the customer site). Furthermore, the network traffic that is permitted to flow from the customer site toward the core network may be rerouted by the broadband network gateway to the processing system, which may be part of a dedicated application server that functions as a self-service Web portal for establishing a fiber broadband service (or other communications service) subscription.

In step 306, the processing system may deliver, to the endpoint device, information associated with a communication service plan (broadly one or more communication service plans) that is available to a customer site associated with the optical network terminal. As discussed above, the processing system may be part of a dedicated application server that functions as a self-service Web portal for establishing a fiber broadband service (or other communication service) subscription. In one example, the information delivered to the endpoint device may include information about fiber broadband service subscription plans that are available to the customer site. For instance, the information may include data rates and pricing associated with a plurality of different fiber broadband subscription plans. In a further example, the information may include information about other communication service subscription plans that are available to the customer site, such as streaming media (e.g., video and/or audio), television services, telephone services, or the like. Thus, the communication service plan for which information is delivered in step 306 may be one of a plurality of communication service plans for which information is delivered to the endpoint device.

In step 308, the processing system may receive a selection of the communication service plan (or a selection of a communication service plan from a plurality of communication service plans) from the endpoint device. For instance, a user of the endpoint device may review the information delivered by the processing system in step 306 and may elect, based on the information, to subscribe to the communication service plan. The user may send a signal to the processing system, via the endpoint device, indicating the selection of the communication service plan. Thus, the selection may indicate the service to which the user wishes to subscribe (e.g., fiber broadband, streaming media, television, telephone, etc.), desired parameters of the service (e.g., data rate, inclusion of advertisements, number of devices permitted to be connected overall or simultaneously, and/or other parameters, if applicable), a desired length of time for which the user wishes to subscribe to the service (e.g., month to month, one year, etc.), and/or a cost associated with the service (e.g., x dollars per month, y dollars per year, etc.).

In optional step 310 (illustrated in phantom), the processing system may engage a backend system needed to perform a provisioning/verification process needed to establish service in accordance with the communication service plan at the customer site. For instance, before service can be delivered to the customer site, it may be necessary to perform one or more verification processes, such as a credit check for the user in whose name the service is to be established, verification that the user in whose name the service is to be established resides at an address associated with the customer site, verification that hardware and/or software at the customer site (e.g., the optical network terminal) is up to date or is compatible with the selected communication service plan, and/or other processes. To perform these verification processes, the processing system may send an instruction to one or more remote systems (e.g., other servers) to perform the verification processes. The one or more remote systems may then send the results of the verification processes to the processing system.

In one example, the method 300 may not proceed to the next step (e.g., step 312) unless and until all necessary verification processes have been performed and the results of those verification processes do not indicate any reasons as to why the selected communication service plan cannot be established (e.g., user credit score is below a threshold, user does not reside at the address associated with the customer site, hardware at the customer site must be replaced, etc.).

In step 312, the processing system may configure a customer policy for the customer site in accordance with the selection. As discussed above, the customer policy may specify how traffic from the optical network terminal at the customer site is to be processed. For instance, the customer policy may determine as to where the traffic from the optical network terminal is to be routed and how much bandwidth is to be allocated to the user to whom the optical network terminal belongs.

The processing system may configure the customer policy based on the selection of the communication service plan. For instance, in one example, each communication service plan for which information is delivered in step 306 may be associated with a set of preconfigured parameters (e.g., data rate, inclusion of advertisements, number of devices permitted to be connected overall or simultaneously, and/or other parameters, if applicable), and the user may simply select the communication service plan having the set of preconfigured parameters that best suits their needs. The customer policy may be configured to deliver the communication service plan to the customer site (e.g., to process traffic from the optical network terminal) in a manner that satisfies these preconfigured parameters. In another example, the selection of the communication service plan may include one or more of a la carte selections of parameters. In this case, the processing system may parse the selection for the selected parameters and may configure the customer policy to deliver the communication service plan to the customer site (e.g., to process traffic from the optical network terminal) in a manner that satisfies the selected parameters.

In step 314, the processing system may deliver the customer policy to the broadband network gateway with an instruction to replace a default policy associated with the customer site with the customer policy. As discussed above, once a new customer policy has been configured for a customer site at which fiber broadband service was previously discontinued, the new customer policy may replace a default policy for the customer site in the broadband network gateway. Once the broadband network gateway has replaced the default policy with the new customer policy, future network traffic may be enabled to flow from the customer site (i.e., from the optical network terminal at the customer site) to a core network and/or the Internet, and from the core network and/or the Internet to the customer site (i.e., without rerouting to the processing system). In other words, future network traffic from the optical network terminal at the customer site will be processed by the broadband network gateway in accordance with the new customer policy. Thus, fiber broadband service will now be up and running at the customer site.

In step 316, the method 300 may end.

It should be noted that the method 200 and the method 300 may be expanded to include additional steps or may be modified to include additional operations with respect to the steps outlined above. In addition, although not specifically specified, one or more steps, functions, or operations of the method 200 and the method 300 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 or FIG. 3 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 providing automated delivery of fiber broadband service, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 or the method 300 as discussed above is implemented in a distributed or parallel manner for a particular illustrative example, i.e., the steps of the above method 200 or the method 300 or the entire method 200 or method 300 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200 or method 300. In one example, instructions and data for the present module or process 405 for providing automated delivery of fiber broadband service (e.g., a software program comprising computer-executable instructions) can be loaded into memory 404 and executed by hardware processor element 402 to implement the steps, functions, or operations as discussed above in connection with the illustrative method 200 or method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for providing automated delivery of fiber broadband service (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
detecting, by a processing system in a communications service provider access network, network traffic from an endpoint device connected to an optical network terminal for which a fiber broadband service has been discontinued, wherein the network traffic has been rerouted by a broadband network gateway;
delivering, by the processing system to the endpoint device, information associated with at least one communication service plan that is available to a customer site associated with the optical network terminal;
receiving, by the processing system, a selection of the at least one communication service plan from the endpoint device;
configuring, by the processing system, a customer policy for the customer site in accordance with the selection; and
delivering, by the processing system, the customer policy to the broadband network gateway with an instruction to replace a default policy associated with the customer site with the customer policy.

2. The method of claim 1, wherein the network traffic is directed toward a core network to which the communications service provider access network is connected, and the default policy causes the broadband network gateway to reroute the network traffic to the processing system.

3. The method of claim 2, wherein a replacement of the default policy with the customer policy will cause the broadband network gateway to process future network traffic from the optical network terminal in accordance with the customer policy.

4. The method of claim 3, wherein the future network traffic that is directed toward the core network will be permitted to proceed to the core network without rerouting to the processing system.

5. The method of claim 1, wherein the processing system is part of a dedicated application server that serves as a self-service web portal for subscribing to and establishing service according to the at least one communication service plan.

6. The method of claim 1, wherein the at least one communication service plan is one of a plurality of communication service plans for which information is delivered to the endpoint device.

7. The method of claim 1, wherein the at least one communication service plan is a fiber broadband service plan.

8. The method of claim 7, wherein the information includes a data rate and a price.

9. The method of claim 1, wherein the at least one communication service plan is associated with at least one of: a streaming media service, a television service, or a telephone service.

10. The method of claim 9, wherein the information includes at least one service parameter and a price.

11. The method of claim 10, wherein the at least one service parameter includes at least one of: a data rate, whether advertisements are to be included, or a number of devices permitted to be connected to the at least one communication service plan.

12. The method of claim 1, wherein the at least one communication service plan is associated with a set of preconfigured parameters that govern how traffic from the optical network terminal is to be processed.

13. The method of claim 12, wherein the configuring comprises configuring the customer policy to process traffic from the optical network terminal in a manner that satisfies the set of preconfigured parameters.

14. The method of claim 1, wherein the selection includes a plurality of a la carte selections of parameters that govern how traffic from the optical network terminal is to be processed.

15. The method of claim 14, wherein the configuring comprises parsing the selection for the selections of the parameters and configuring the customer policy to process traffic from the optical network terminal in a manner that satisfies the selections of the parameters.

16. The method of claim 1, further comprising:
engaging, by the processing system, a backend system needed to perform a process needed to establish service in accordance with the at least one communication service plan at the customer site.

17. The method of claim 16, wherein the process needed to establish service comprises at least one of: a credit check for a user in whose name the communication service plan is to be established, a verification that the user resides at an address associated with the customer site, or a verification that hardware and software at the customer site is compatible with the at least one communication service plan.

18. The method of claim 16, wherein the configuring and the delivering the customer policy cannot proceed until the process needed to establish service has been completed.

19. A non-transitory computer-readable medium storing instructions which, when executed by a processing system in a communications service provider access network, the processing system including at least one processor, cause the processing system to perform operations, the operations comprising:
detecting network traffic from an endpoint device connected to an optical network terminal for which a fiber broadband service has been discontinued, wherein the network traffic has been rerouted by a broadband network gateway;
delivering, to the endpoint device, information associated with at least one communication service plan that is available to a customer site associated with the optical network terminal;
receiving a selection of the at least one communication service plan from the endpoint device;
configuring a customer policy for the customer site in accordance with the selection; and
delivering the customer policy to the broadband network gateway with an instruction to replace a default policy associated with the customer site with the customer policy.

20. A device comprising:
a processing system in a communications service provider access network, the processing system including at least one processor; and
a non-transitory computer-readable medium storing instructions which, when executed by the processing system, cause the processing system to perform operations, the operations comprising:
detecting network traffic from an endpoint device connected to an optical network terminal for which a fiber broadband service has been discontinued, wherein the network traffic has been rerouted by a broadband network gateway;
delivering, to the endpoint device, information associated with at least one communication service plan that is available to a customer site associated with the optical network terminal;
receiving a selection of the at least one communication service plan from the endpoint device;
configuring a customer policy for the customer site in accordance with the selection; and
delivering the customer policy to the broadband network gateway with an instruction to replace a default policy associated with the customer site with the customer policy.
